(19) United States
(12) Patent Application Publication
(10) Pub. No.: US 2026/0103193 A1
(43) Pub. Date: Apr. 16, 2026

(54) Operating an Adaptive Cruise Control for a Motor Vehicle that has a High Beam Assistant

(71) Applicant: Bayerische Motoren Werke Aktiengesellschaft, Muenchen (DE)

(72) Inventors: Philip AVDIMETAJ, Aschau (DE); Christian SCHWALBACH, Muenchen (DE)

(21) Appl. No.: 19/353,672

(22) Filed: Oct. 9, 2025

(30) Foreign Application Priority Data
Oct. 10, 2024 (DE) 10 2024 129 216.4

(51) Int. Cl. B60W 30/16; B60Q 1/08

(52) U.S. Cl. CPC B60W 30/16; B60Q 1/08; B60Q 2300/41; B60W 2554/802

(57) ABSTRACT

A method for operating an adaptive cruise control for a motor vehicle that has a high beam assistant is provided. The method includes recording a high beam information item relating to an automated high beam function of the high beam assistant, the high beam information item including a distance information item, the distance information item characterizing a distance between the motor vehicle and a preceding vehicle, and the distance representing a threshold for the activation and/or deactivation of the high beam function of the high beam assistant; determining a minimum designated distance between the motor vehicle and the preceding vehicle with the aid of the high beam information item including the distance information item; and outputting a control signal for operating the adaptive cruise control while complying with the minimum designated distance.

### CROSS REFERENCE TO RELATED APPLICATION

This application claims priority under 35 U.S.C. §119 from German Patent Application No. 102024129 216.4, filed October 10, 2024, the entire disclosure of which is herein expressly incorporated by reference.

### BACKGROUND AND SUMMARY

The present disclosure relates to a method for operating an adaptive cruise control for a motor vehicle that has a high beam assistant. The disclosure also relates to a computer program and/or computer-readable medium, to a data processing device, to an adaptive cruise control for a motor vehicle that has a high beam assistant, and to a motor vehicle.

Such an adaptive cruise control (ACC) and such a high beam assistant are driver assistance systems and are known per se from the prior art. The adaptive cruise control is intended to maintain a distance between the motor vehicle and a preceding vehicle. An automatic increase and/or reduction of the distance by a factor may take place according to the speed of the motor vehicle.

A high beam assistant is intended, for example, to automatically dip the headlights, i.e., activate a low beam and deactivate a high beam, and/or turn up the headlights, i.e., activate the high beam. A high beam assistant may also be adapted, when following a preceding vehicle, or target object, to illuminate particular regions around the preceding vehicle and/or leave them unlit.

DE 102011007181 A1 discloses an exterior light control system for a motor vehicle. In the exterior light control system, particularly a headlamp system, for a motor vehicle, having an electronic controller for ascertaining and adjusting a predefined luminous intensity and/or for ascertaining and adjusting a predefined horizontal and/or vertical tilt angle of at least one headlamp that can be tilted through a particular angle range, the controller is configured in such a way that the luminous intensity and/or the tilt angle is and/or are variably predefined according to the distance of the host motor vehicle from a preceding and/or following vehicle.

DE 102014221883 A1 relates to a method for adjusting a light emission of at least one headlamp of a vehicle. The method comprises a step of determining whether or not a different vehicle is concealed by at least one obstacle as seen from the vehicle. The method also comprises a step of changing the light emission from an initial characteristic to a target characteristic when the other vehicle is revealed for longer than a definable waiting time.

DE 102009061874 B3 relates to a method for controlling a headlamp arrangement of a vehicle, in which preceding and oncoming road users are detected in front of the vehicle in the driving direction and the light distribution generated by the headlamp arrangement is regulated so that it has a lighting range in the direction of a detected preceding road user that is less than the distance to the detected preceding road user, and its lighting range in the direction of the adjacent lane is switched depending on the detection of a further road user alternately between at least a first lighting state with increased illumination of the adjacent lane and a second lighting state with reduced illumination of the adjacent lane, the switching between the two lighting states for the lighting range in the direction of the adjacent lane being delayed according to the detection rate of the further road users, in particular oncoming road users and optionally depending on changes in the steering angle of the vehicle as a function of time. The method is characterized in that it detects whether a multi-lane road is being used and a switch is made to the second lighting state for the adjacent lane if a multi-lane road has been detected.

In the case of an active adaptive cruise control and a relatively short distance, however, the automatic high beam may become deactivated in order not to dazzle a driver of the preceding vehicle. As a result of distances selected by the adaptive cruise control that are too close for the high beam assistant, it may occur that the adaptive high beam is completely deactivated if the longitudinal regulation is activated.

This can lead to a reduced and/or improvable illumination of the environment and may even be safely-relevant. Particularly for drivers of the motor vehicle who know how to judge the safety aspect of the additional illumination by the high beam assistant, this may lead to a negative driver experience, a reduced feeling of safety and/or increased stress.

Against the background of this prior art, it is an object of the present disclosure to specify a method and a device that are each suitable for enlarging the prior art and improving at least the aforementioned aspects of the prior art. In particular, the object of the disclosure is to be able to provide a cruise control during which an improved illumination of the environment of the motor vehicle can be attained.

The object is achieved by the features of the independent claims. The dependent claims contain developments of the disclosure.

Accordingly, the object is achieved according to one aspect of the disclosure by a method for operating an adaptive cruise control for a motor vehicle that has a high beam assistant, wherein the method comprises: recording a high beam information item relating to an automated high beam function of the high beam assistant, the high beam information item comprising a distance information item, the distance information item characterizing a distance between the motor vehicle and a preceding vehicle, and the distance representing a threshold for the activation and/or deactivation of the high beam function of the high beam assistant; determining a minimum designated distance between the motor vehicle and the preceding vehicle with the aid of the high beam information item comprising the distance information item; and outputting a control signal for operating the adaptive cruise control while complying with the minimum designated distance.

It has been discovered that the distance between the motor vehicle and the preceding vehicle can be critical for a deactivation of the high beam function. In other words, it is therefore proposed that a limitation of the minimum distance should take place during a longitudinal regulation of the motor vehicle by the adaptive cruise control if the high beam function is activated, or if the adaptive high beam assistant is activated.

To this end the distance information item, which is crucial for the limitation of the designated distance defined by the adaptive cruise control, is recorded. The designated distance is accordingly replaced with the minimum designated distance, which is larger than the designated difference, i.e. it is restricted or limited downward by the minimum designated distance. It is therefore possible to ensure that the distance between the motor vehicle and the preceding vehicle does not fall below the threshold for the activation and/or deactivation of the high beam function of the high beam assistant. In this way, the high beam function and/or the high beam assistant can remain activated.

The cruise control offers a possibility of continuous activation of the high beam function and/or of the high beam assistant. This can lead to an improved illumination of the environment of the motor vehicle, even if the adaptive cruise control is active.

Optionally, the distance information item characterizes the distance and a distance buffer. The distance buffer makes it possible that the minimum designated distance can be determined even further away from the threshold for the activation and/or deactivation of the high beam function of the high beam assistant. In this way, the high beam function and/or high beam assistant can remain activated even in the event of distance fluctuations around the threshold.

Optionally, the high beam information item comprises a status indicator that characterizes the high beam assistant and/or the high beam function. In this context, it has been discovered that the high beam assistant and/or the high beam function need not always remain activated. If the high beam assistant and/or the high beam function is deactivated, this may be established with the aid of the status indicator and entail regulation to the designated distance. Otherwise, if the high beam assistant and/or the high beam function is activated, this may be established with the aid of the status indicator and entail regulation to the minimum designated distance.

Optionally, the minimum designated distance is greater than a designated distance that is defined by the adaptive cruise control without taking account of the high beam assistant and/or the high beam function. In this context, it has been discovered that the adaptive cruise control defines a designated distance that is, for example, speed-dependent. It is reliably possible to avoid falling below the threshold for the activation and/or deactivation of the high beam function of the high beam assistant if the minimum designated distance is greater than the designated distance.

Optionally, the minimum designated distance is determined in such a way that the high beam assistant can illuminate an environment around the preceding vehicle. In this context, it has been discovered that full beam can illuminate the environment of the preceding vehicle partially and/or in particular portions. This may crucially depend on information items that are known to the high beam assistant and characterize the lighting. The capability of illuminating the environment of the preceding vehicle may inter alia depend on the distance between the motor vehicle and the preceding vehicle. This may be taken into account when determining the designated distance.

According to one aspect of the disclosure, a computer program and/or computer-readable medium is provided. The computer program and/or the computer-readable medium comprise instructions which, when the program or the instructions are executed by a data processing device, cause the latter to carry out the method according to the disclosure and/or steps thereof. Optionally, the computer program and/or the computer-readable medium comprises instructions which, when the program or the instructions are executed by a data processing device, cause the latter to carry out the method steps described as advantageous or optional in order to achieve a technical effect associated therewith.

According to one aspect of the disclosure, a data processing device for a motor vehicle is provided. The data processing device is adapted to carry out the method according to the disclosure. Optionally, the data processing device is adapted to carry out a method step described as advantageous or optional and/or to implement a method feature in order to achieve a technical effect associated therewith.

According to one aspect of the disclosure, an adaptive cruise control for a motor vehicle that has a high beam assistant, comprising the data processing device according to the disclosure is provided. The adaptive cruise control and/or the data processing device is adapted to carry out the method according to the disclosure. Optionally, the adaptive cruise control and/or the data processing device is adapted to carry out a method step described as advantageous or optional and/or to implement a method feature in order to achieve a technical effect associated therewith.

According to one aspect of the disclosure, a motor vehicle comprising an adaptive cruise control according to the disclosure and a high beam assistant is provided. Optionally, the data processing device of the motor vehicle, the adaptive cruise control and/or the motor vehicle is adapted to carry out a method step described as advantageous or optional and/or to implement a method feature in order to achieve a technical effect associated therewith.

An embodiment is described below with reference to the figures:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a motor vehicle having an adaptive cruise control according to one aspect of the disclosure;

FIG. 2 schematically shows a flowchart of a method according to one aspect of the disclosure; and

FIG. 3 shows a schematic representation of a computer program and/or computer-readable medium according to one aspect of the disclosure.

### DETAILED DESCRIPTION OF THE DRAWINGS

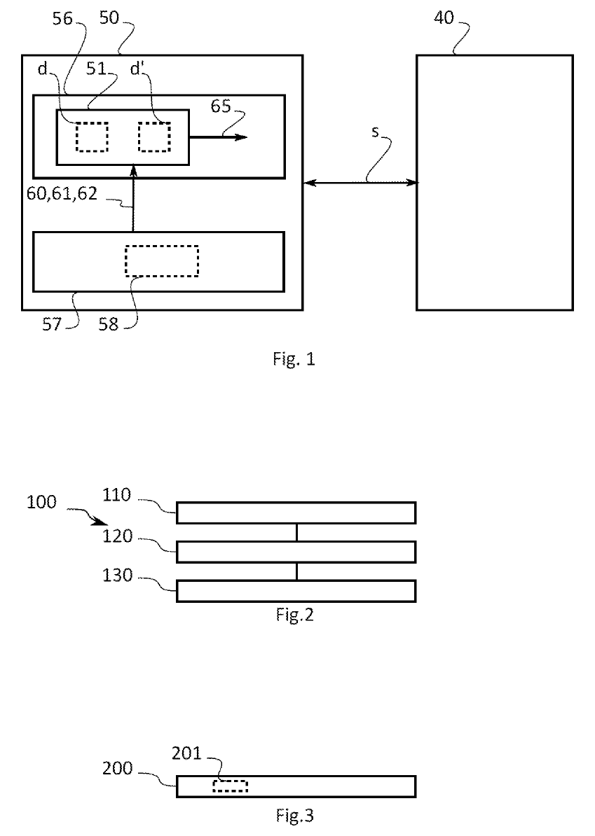

FIG. 1 schematically shows a motor vehicle 50 having an adaptive cruise control 56 according to one aspect of the disclosure. FIG. 1 also shows a preceding vehicle 40.

The motor vehicle 50 is a land vehicle. The motor vehicle 50 is, for example, an automobile. The preceding vehicle 40 is a further motor vehicle arranged and/or driving in front of the motor vehicle 50 on a road lane (not shown). The preceding vehicle 40 is arranged at a distance s from the motor vehicle 50 in the driving direction of the motor vehicle 50.

The motor vehicle 50 is adapted to carry out autonomous and/or automated driving functions. To this end, the motor vehicle 50 has an adaptive cruise control 56 and a high beam assistant 57. In the example shown according to FIG. 1, the adaptive cruise control 56 has a data processing device 51. The adaptive cruise control 56 may also have further components (not shown), for example, sensors for recording the distance s and/or interfaces to sensors for recording the distance s.

The adaptive cruise control 56 is adapted to regulate the distance s to a designated distance d’ and/or to a minimum designated distance d. The designated distance d’ is in this case a distance s between the motor vehicle 50 and the preceding vehicle 40, which is defined by the adaptive cruise control 56 and which may depend on the speed of the motor vehicle 50.

The high beam assistant 57 is adapted to carry out an automated high beam function 58. The high beam function 58 may comprise automated turning up and/or dipping of the headlights and/or may be adapted to illuminate an environment of the motor vehicle 50 and/or of the preceding vehicle 40 fully or in portions.

The data processing device 51, the adaptive cruise control 56, or the motor vehicle 50, is adapted to carry out the method 100 described with reference to FIG. 2.

To this end, the data processing device 51 according to FIG. 1 is adapted to record a high beam information item 60 relating to the automated high beam function 58 of the high beam assistant 57. To this end, the high beam information item 60 may be provided by the high beam assistant 57 on a vehicle bus, in particular a CAN bus, and read by the data processing device 51.

The high beam information item 60 comprises a distance information item 61. The distance information item 61 characterizes a distance s between the motor vehicle 50 and a preceding vehicle 40, the distance s of the distance information item 61 representing a threshold for the activation and/or deactivation of the high beam function 58 of the high beam assistant 57. The distance s transmitted with the distance information item 61 to the data processing device 51 thus represents a distance s, which is defined by the high beam assistant 57, above which the high beam function 58 and/or the high beam assistant 57 is activated and/or below which the high beam function 58 and/or the high beam assistant 57 is deactivated. The distance information item 61 characterizes the distance s and a distance buffer. The distance buffer may be positive and added to the distance s that is transmitted with the distance information item 61 to the data processing device 51, in order to avoid a status alternation of the high beam function 58 and/or of the high beam assistant 57 in the event of distance fluctuations and/or distance changes.

The high beam information item 60 comprises a status indicator 62 that characterizes the high beam assistant 57 and/or the high beam function 58. The status indicator 62 may specify whether the high beam assistant 57 and/or the high beam function 58 is activated and/or deactivated. Optionally, in the case of an active high beam assistant 57 and/or an active high beam function 58, the status indicator 62 may specify an operating mode and/or operating parameter, for example for illuminating the environment.

The data processing device 51 is adapted to determine the minimum designated distance d between the motor vehicle 50 and the preceding vehicle 40 with the aid of the high beam information item 60 comprising the distance information item 61. An information item transmitted to the high beam assistant 57 is therefore taken into account when determining the minimum designated distance d, namely the distance information item 61 and optionally the distance buffer, but the designated distance d’ is determined solely based on the adaptive cruise control 56, i.e., without taking into account the high beam assistant 57. The minimum designated distance d is greater than the designated distance d’ defined by the adaptive cruise control 56 without taking account of the high beam assistant 57 and/or the high beam function 58. The minimum designated distance d is determined in such a way that the high beam assistant 57 can illuminate an environment of the preceding vehicle 40. For this purpose, the high beam information item 60 may comprise information items characterizing the operating mode and/or operating parameter for illuminating the environment.

The data processing device 51 is adapted to output a control signal 65 for operating the adaptive cruise control 56 while complying with the minimum designated distance d. The control signal 65 therefore causes the adaptive cruise control 56 to adopt the minimum designated distance d as a control variable and/or to regulate the distance s while taking into account the minimum designated distance d as a lower bound.

In another embodiment (not shown), the motor vehicle 50 may have a different architecture. For example, the adaptive cruise control 56 and/or the high beam assistant 57 may be embodied as a software module contained by the data processing device 51.

FIG. 2 schematically shows a flowchart of a method 100 according to one aspect of the disclosure. The method 100 according to FIG. 2 is a method 100 for operating an adaptive cruise control 56 for a motor vehicle 50 that has a high beam assistant 57. Such a motor vehicle 50 and such an adaptive cruise control 56 are described with reference to FIG. 1. FIG. 2 is described whilst referring to FIG. 1.

The method 100 according to FIG. 2 comprises: recording 110 a high beam information item 60 relating to an automated high beam function 58 of the high beam assistant 57, the high beam information item 60 comprising a distance information item 61, the distance information item 61 characterizing a distance between the motor vehicle 50 and a preceding vehicle 40, and the distance representing a threshold for the activation and/or deactivation of the high beam function 58 of the high beam assistant 57.

The distance information item 61 characterizes the distance and a distance buffer.

The high beam information item 60 comprises a status indicator 62 that characterizes the high beam assistant 57 and/or the high beam function 58.

The method 100 comprises: determining 120 a minimum designated distance d between the motor vehicle 50 and the preceding vehicle 40 with the aid of the high beam information item 60 comprising the distance information item 61.

The minimum designated distance d is greater than a designated distance d’ that is defined by the adaptive cruise control 56 without taking account of the high beam assistant 57 and/or the high beam function 58.

The minimum designated distance d is determined in such a way that the high beam assistant 57 can illuminate an environment around the preceding vehicle 40.

The method 100 comprises: outputting 130 a control signal 65 for operating the adaptive cruise control 56 while complying with the minimum designated distance d.

A person skilled in the art will understand that the method 100 according to FIG. 2 may also be carried out in an order different than the order presented. In particular, steps of the method 100 may be interchanged, moved, carried out repeatedly and/or carried out simultaneously.

In other words, the method 100 is carried out as follows: during active driver assistance by the adaptive cruise control 56 and by the high beam assistant 57, the minimum distance s is restricted downward. This takes place in such a way that the lower limit for the distance s, at which the high beam function 58 can be carried out, is established in the functional range of the high beam assistant 57, for example, according to the speed. A least distance from the preceding vehicle 40 is necessary so that illumination can take place around the latter. This least distance is the minimum designated distance d, optionally while taking into account the distance buffer.

The high beam assistant 57 is usable in principle, for example, only above a speed of the motor vehicle 50 equal to 50 km/h, while no activation of the high beam is performed at lower speeds. If the driver is driving faster than this speed with active driver assistance by the adaptive cruise control 56 and by the high beam assistant 57, a minimum designated distance d is calculated. On the basis of the second gap, which is stored for each distance level, and possible further adaptive factors, the minimum designated distance d to be adjusted is specified in meters by default. If it lies below the designated distance d’ determined by the adaptive cruise control 56, then the previously calculated minimum designated distance d is used as a distance target instead of the designated distance d’. This least distance is therefore given primarily by the cut-off angle of the adaptive headlamps and the current speed. An availability variable may be constantly calculated by the calculation unit of the adaptive headlamps and forwarded to the longitudinal regulation, so that the actual least distance is provided.

FIG. 3 shows a schematic representation of a computer program and/or computer-readable medium 200 according to one aspect of the disclosure. The computer program and/or computer-readable medium 200 comprises instructions 201 which, when the program or the instructions 201 are executed by a data processing device 51, cause the latter to carry out the method 100 and/or the steps of the method 100 according to FIG. 2.

The instructions 201 may be in the form of a program code in any desired code, or any desired language, particularly in a code that is suitable for controls and/or the monitoring of motor vehicles 50, their high beam assistant 57 and/or their adaptive cruise control 56. The computer program and/or computer-readable medium 200 may be or comprise any desired digital storage device, for example a USB stick, a hard disk drive, a CD-ROM, an SD card or an SSD card. The computer program need not necessarily be stored on such a computer-readable storage medium, but may also be accessible via the Internet or in another way.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of reference signs

40 preceding vehicle

50 motor vehicle

51 data processing device

56 adaptive cruise control

57 high beam assistant

58 automated high beam function

60 high beam information item

61 distance information item

62 status indicator

65 control signal

100 method

110 recording

120 determination

130 output

200 computer program and/or computer-readable medium

201 instructions

d minimum designated distance

d’ designated distance

s distance.

What is claimed is:

1. A method for operating an adaptive cruise control for a motor vehicle that has a high beam assistant, the method comprising:
recording a high beam information item relating to an automated high beam function of the high beam assistant, the high beam information item including a distance information item, the distance information item characterizing a distance between the motor vehicle and a preceding vehicle, and the distance representing a threshold for activation or deactivation of the high beam function of the high beam assistant;
determining a minimum designated distance between the motor vehicle and the preceding vehicle based on the high beam information item including the distance information item; and
outputting a control signal for operating the adaptive cruise control while complying with the minimum designated distance.

2. The method according to claim 1, wherein the distance information item characterizes the distance and a distance buffer.

3. The method according to claim 1, wherein the high beam information item comprises a status indicator that characterizes the high beam assistant or the high beam function.

4. The method according to claim 2, wherein the high beam information item comprises a status indicator that characterizes the high beam assistant or the high beam function.

5. The method according to claim 1, wherein the minimum designated distance is greater than a designated distance that is defined by the adaptive cruise control without taking account of the high beam assistant or the high beam function.

6. The method according to claim 2, wherein the minimum designated distance is greater than a designated distance that is defined by the adaptive cruise control without taking account of the high beam assistant or the high beam function.

7. The method according to claim 3, wherein the minimum designated distance is greater than a designated distance that is defined by the adaptive cruise control without taking account of the high beam assistant or the high beam function.

8. The method according to claim 1, wherein the minimum designated distance is determined such that the high beam assistant illuminates an environment around the preceding vehicle.

9. The method according to claim 2, wherein the minimum designated distance is determined such that the high beam assistant illuminates an environment around the preceding vehicle.

10. The method according to claim 3, wherein the minimum designated distance is determined such that the high beam assistant illuminates an environment around the preceding vehicle.

11. A non-transitory computer-readable medium storing instructions which, when executed by a data processing device, cause the data processing device to carry out a method for operating an adaptive cruise control for a motor vehicle that has a high beam assistant comprising:
recording a high beam information item relating to an automated high beam function of the high beam assistant, the high beam information item including a distance information item, the distance information item characterizing a distance between the motor vehicle and a preceding vehicle, and the distance representing a threshold for activation or deactivation of the high beam function of the high beam assistant;
determining a minimum designated distance between the motor vehicle and the preceding vehicle based on the high beam information item including the distance information item; and
outputting a control signal for operating the adaptive cruise control while complying with the minimum designated distance.

12. The non-transitory computer-readable medium according to claim 11, wherein the distance information item characterizes the distance and a distance buffer.

13. The non-transitory computer-readable medium according to claim 11, wherein the high beam information item comprises a status indicator that characterizes the high beam assistant or the high beam function.

14. A data processing device for a motor vehicle, wherein the data processing device is adapted to carry out a method according to claim 1.

15. The data processing device according to claim 14, wherein the distance information item characterizes the distance and a distance buffer.

16. The data processing device according to claim 14, wherein the high beam information item comprises a status indicator that characterizes the high beam assistant or the high beam function.

17. An adaptive cruise control for a motor vehicle that has a high beam assistant, comprising the data processing device according to claim 14.

18. A motor vehicle comprising an adaptive cruise control according to claim 17 and a high beam assistant.
